(19) United States
(12) Patent Application Publication
(10) Pub. No.: US 2016/0368428 A1
(43) Pub. Date: Dec. 22, 2016

(54) BAG HOLDING BRACKET

(71) Applicant: David Stiff, Welaka, FL (US)

(72) Inventor: David Stiff, Welaka, FL (US)

(21) Appl. No.: 14/744,925

(22) Filed: Jun. 19, 2015

(51) Int. Cl. B60R 11/00

(52) U.S. Cl. CPC B60R 11/00; B60R 2011/0007; B60R 2011/0071; B60R 2011/0052; B60R 2011/0077

(57) ABSTRACT

A bag holding bracket that is mounted within a vehicle to support a trash bag is provided. The bracket includes a mounting plate having an inner surface and an outer surface. At least one clip may extend from the mounting plate. For example, at least one clip may extend from a forward edge of the mounting plate. The present invention further includes a connector that secures the mounting plate to a back portion of a center console body of a vehicle.

### BACKGROUND OF THE INVENTION

The present invention relates to securing a trash bag within a vehicle and, more particularly, to a bag holding bracket to secure a trash bag within a vehicle.

Trash may accumulate within a vehicle. To prevent trash build up, users may resort to having trash bags within their vehicle. Currently, generic hooks may be hung from a headrest of a car or within the front seat areas. However, the generic hooks may take up needed space, and are not accessible by all passengers within the vehicle. Further, the bag may easily fall off from the hook when the bag is empty.

As can be seen, there is a need for an improved device for hanging trash bags within a vehicle.

### SUMMARY OF THE INVENTION

In one aspect of the present invention, a bag holding bracket comprises: a mounting plate comprising an inner surface opposite an outer surface; at least one clip extending from the mounting plate; and a connector configured to attach the mounting plate to a back portion of a center console of a vehicle.

In another aspect of the present invention, a method of securing a trash bag within a vehicle comprises: providing a bag holding bracket comprising a mounting plate and at least one clip extending from the mounting plate; securing the mounting plate in between a center console hinge and a center console body of a vehicle; and attaching a bag to the at least one clip.

In another aspect of the present invention, A bag holding device comprises: a center console in between two front seats of a vehicle, wherein the center console comprises a back surface facing back seats of the vehicle; and at least one clip attached to and extending from the back surface of the center console.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a front top perspective view of an embodiment of the present invention;

FIG. 3 is a rear bottom perspective view of an embodiment of the present invention;

FIG. 4 is an exploded detail view of the present invention shown installed;

FIG. 5 is a side view of an embodiment of the present invention shown in use;

FIG. 6 is a side view of an embodiment of the present invention shown in use with the lid in an open configuration;

FIG. 7 is a section detail view of the present invention along line 7-7 in FIG. 1;

FIG. 8 is a perspective view of an embodiment of the present invention; and

FIG. 9 is a perspective view of an embodiment of the present invention.

FIG. 10 is a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a bracket having trash bag clips and a retainer designed to hold an empty or full trash bag. The clips and retainer hold the bag so that the opening of the bag is at least partially open for ease of use. The present invention is secured to the back of the center console. When placed in this location the trash bag is easily accessible to all passengers in the front or second row. Due to the placement of the present invention, the bag is also easily accessible to the driver, i.e. the driver may use the trash bag while keeping one hand on the steering wheel and maintain eyes on the road.

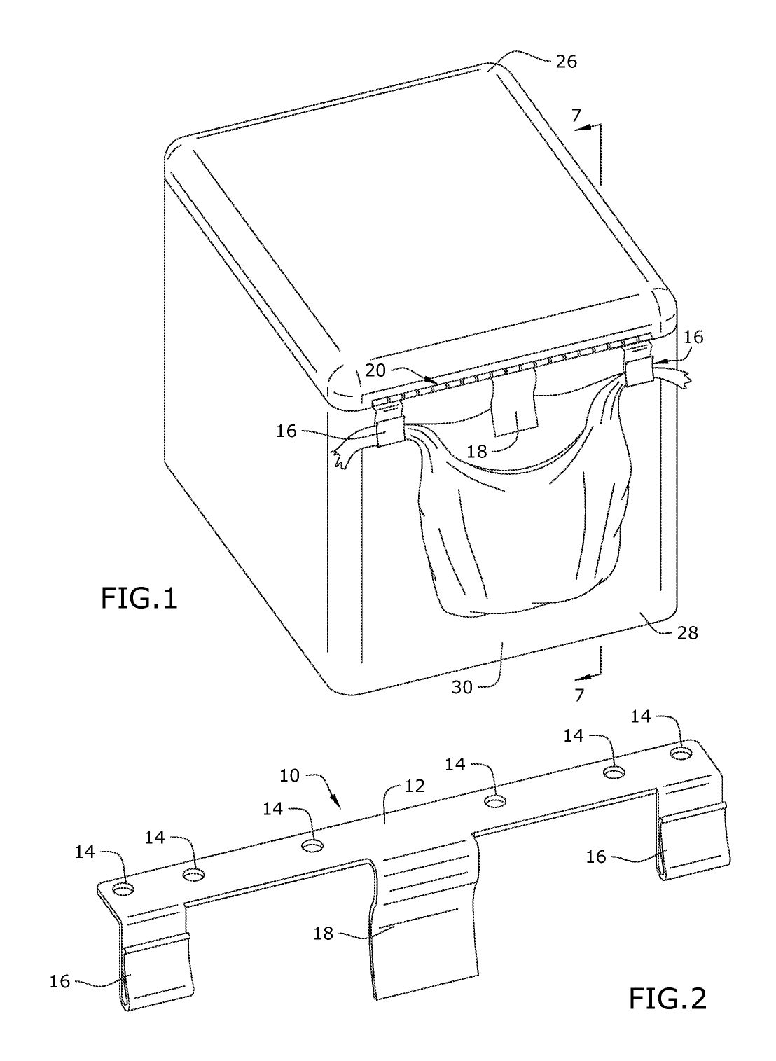

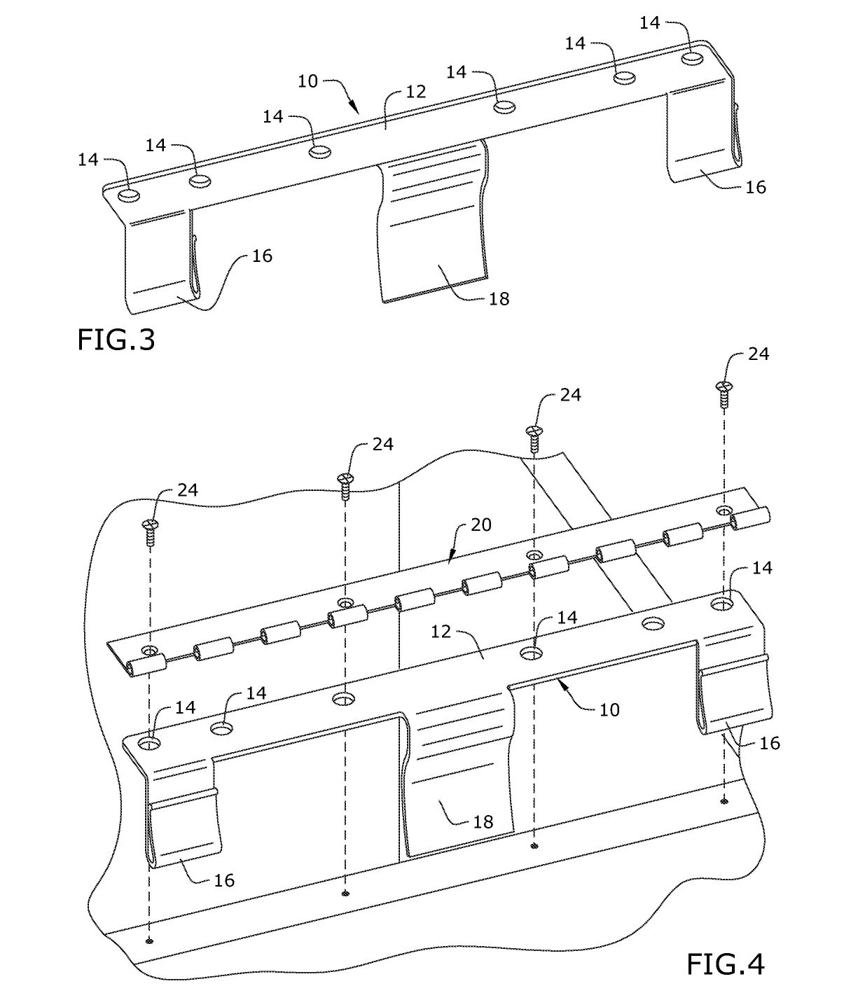

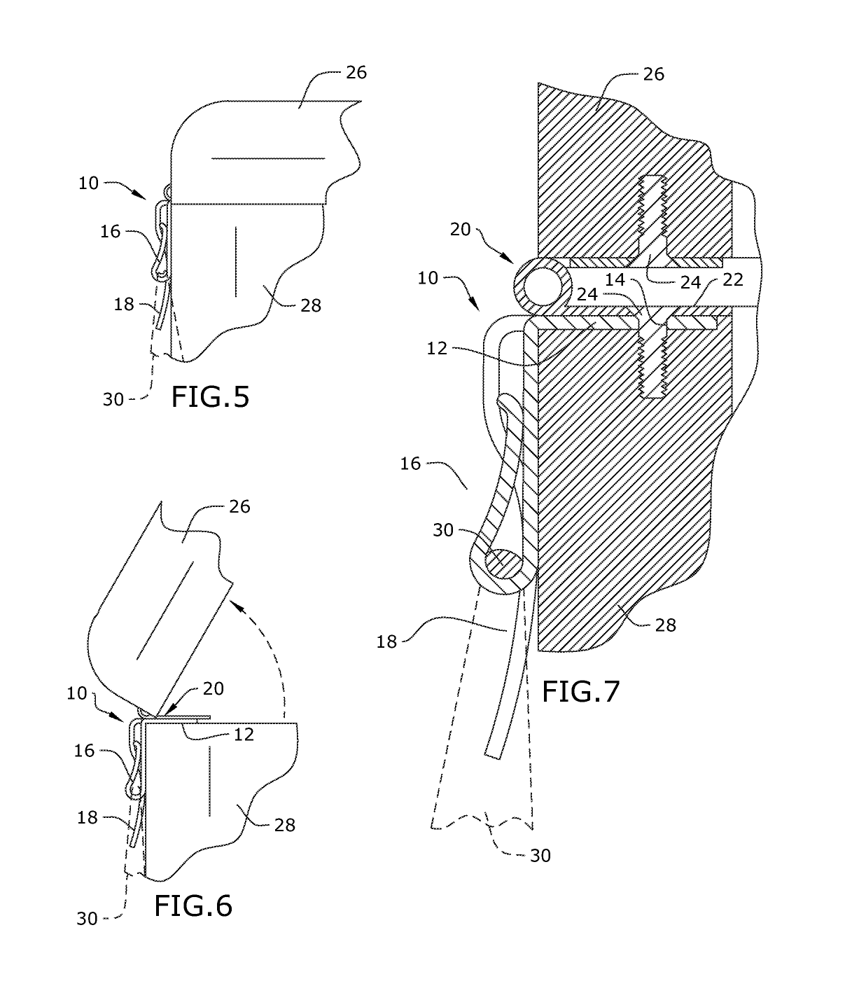

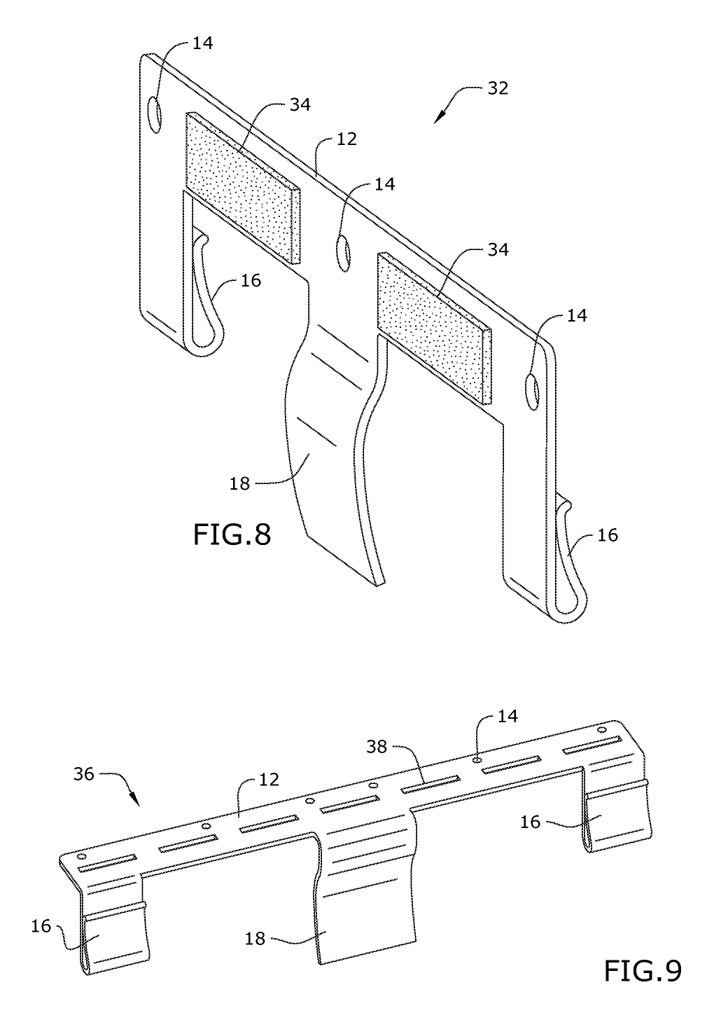

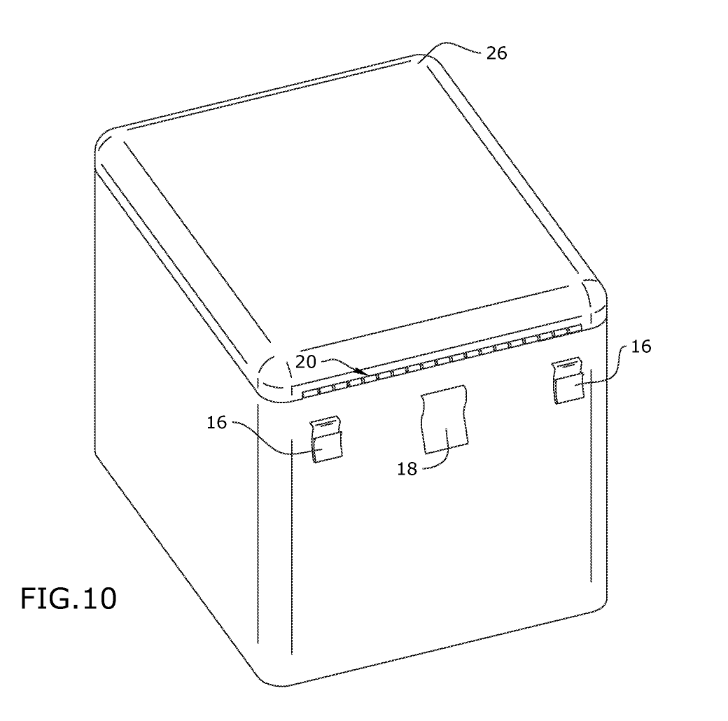

Referring to FIGS. 1 through 9, the present invention includes a bag holding bracket 10 that is mounted within a vehicle to support a trash bag 30. The bracket 10 includes a mounting plate 12 having an inner surface and an outer surface. At least one clip 16 may extend from the mounting plate 12. For example, at least one clip 16 may extend from a forward edge of the mounting plate 12. The present invention further includes a connector 24, 34 that secures the mounting plate 12 to a back portion of a center console body 28 of a vehicle.

As illustrated in the Figures, at least one clip 16 may include a first clip 16 and a second clip 16 extending from opposing ends of the mounting plate 12. The first and second clips 16 may extend from the same forward edge. The clips 16 are formed to retain a portion of the trash bag 30. For example, the clips 16 may include a U-shaped bend, thereby forming a hook. The U-shaped bend may be 180 degrees or greater, such that an end of the clip 16 is touching a body portion of the clip 16 thus serving to retain an empty or near empty bag. In certain embodiments, the clip 16 may include a bent tip, bending away from the mounting plate 12, thereby allowing a portion of the bag 30 to easily slide into the clip 16. The clip 16 is not limited to a hook and may include any type of clip capable of securing a bag 30, such as spring biased clips and the like.

The present invention may further include a retainer 18. The retainer 18 may be used to keep the bag 30 open and may prevent empty trash bags from falling off of the bracket 10. The retainer 18 may extend from the mounting plate 12 in between the first clip 16 and the second clip 16. The retainer 18 may extend in the same direction as the clips 16. The retainer 18 may include a first bend towards the center console 26, 28 and a second bend away from the center console 26, 28. The second bend allows a user to easily slide an upper edge of the bag 30 in between the retainer 18 and the console body 28. The first bend presses the upper edge of the bag 30 against the console body 28, retaining the edge of the bag within and keeping the bag open and secured to the bracket 10, as illustrated in FIG. 1. The retainer 18 may also be made of a flexible material biased towards the center console 26, 28 so that bags 30 may be easily inserted and removed.

In certain embodiments, the clips 16 and the retainer 18 may be substantially perpendicular to the mounting plate 12. The mounting plate 12 may include a plurality of through holes 14. The through holes 14 of the mounting plate 12 may align with through holes of a lower hinge component 22 of a hinge 20. In such embodiments, the connectors 24, 34 may include fasteners 24, such as bolts or screws. The fasteners 24 may run through the aligning through holes of the mounting plate 12 and the hinge 20 and secure the hinge 20 and bracket 10 in between the lid 26 and the body 28 of the center console 26, 28. In such embodiments, the clips 16 may lay flush with the back side of the console base 28.

In certain embodiments, the connector 24, 34 of the present invention may include an adhesive 34. The adhesive 34 may be attached to the inner surface of the mounting plate 12. The mounting plate 12 may then be adhered directly to the body 28 of the console 26, 28. In certain embodiments a plurality of slots 38 may be formed through the mounting plate 12. Therefore, the present invention may connect to the lower hinge plate and connect to the console. In such embodiments, the plate 12 of the present invention may be part of the hinge 20.

In certain embodiments, the present invention may include the clip 16 directly attached to a center console 26, 28. The center console 26, 28 is located in between two front seats of a vehicle and includes a back surface facing the back seats of the vehicle. A first clip 16 and a second clip 16 may be attached to and extending from opposing sides of the back surface of the center console 26, 28. The retainer clip 18 may be attached to and extending from the center console 26, 28 in between the first clip 16 and the second clip 16.

It should be understood, of course, that the foregoing relates to exemplary embodiments of the invention and that modifications may be made without departing from the spirit and scope of the invention as set forth in the following claims.

What is claimed is:

1. A bag holding bracket comprising:
a mounting plate comprising an inner surface opposite an outer surface;
at least one clip extending from the mounting plate; and
a connector configured to attach the mounting plate to a back portion of a center console of a vehicle.

2. The bag holding bracket of claim 1, wherein the at least one clip comprises a first clip and a second clip extending from opposing ends of the mounting plate.

3. The bag holding bracket of claim 2, further comprising a retainer extending from the mounting plate in between the first clip and the second clip, wherein the retainer comprises a first bend towards the center console and a second bend away from the center console.

4. The bag holding bracket of claim 1, wherein the clip comprises a U-shaped bend and a bent tip bending away from the mounting plate.

5. The bag holding bracket of claim 1, wherein the at least one clip is substantially perpendicular relative to the mounting plate.

6. The bag holding bracket of claim 5, wherein the mounting plate comprises a plurality of through holes that align with through holes of a center console hinge.

7. The bag holding bracket of claim 5, wherein the connectors comprise fasteners sized to fit through aligning through holes of the mounting plate and the center console hinge.

8. The bag holding bracket of claim 1, wherein the connector comprises an adhesive disposed on an inner surface of the mounting bracket.

9. A method of securing a trash bag within a vehicle comprising:
providing a bag holding bracket comprising a mounting plate and at least one clip extending from the mounting plate;
securing the mounting plate in between a center console hinge and a center console body of a vehicle; and
attaching a bag to the at least one clip.

10. The method of claim 9, wherein the at least one clip of the bag holding bracket comprises a first clip and a second clip extending from opposing ends of the mounting plate.

11. The method of claim 10, wherein the bag holding bracket further comprises a retainer extending from the mounting plate in between the first clip and the second clip, wherein the retainer comprises a first bend towards the center console and a second bend away from the body center console.

12. The method of claim 11, wherein the step of attaching a bag to the at least one clip comprises:
securing a first end of the bag to the first clip;
securing a second end of the bag to the second clip; and
retaining an upper edge of the bag in between the retainer and the body of the console.

13. A bag holding device comprising:
a center console in between two front seats of a vehicle, wherein the center console comprises a back surface facing back seats of the vehicle; and
at least one clip attached to and extending from the back surface of the center console.

14. The bag holding device of claim 13, wherein at least one clip comprises a first clip and a second clip attached to and extending from opposing sides of the back surface of the center console.

15. The bag holding bracket of claim 13 further comprising a retainer clip attached to and extending from the center console in between the first clip and the second clip, wherein the retainer comprises a first bend towards the center console and a second bend away from the center console.
